(19) United States
(12) Patent Application Publication
(10) Pub. No.: US 2020/0123408 A1
(43) Pub. Date: Apr. 23, 2020

(54) UV-CURING ACRYLIC RESIN COMPOSITIONS FOR THERMOFORMABLE HARD COAT APPLICATIONS

(71) Applicant: Rohm and Haas Electronic Materials LLC, Marlborough, MA (US)

(72) Inventors: Lujia BU, Southborough, MA (US); Yusuke MATSUDA, Glen Mills, PA (US); Michael MULZER, Worcester, MA (US); Yinjie CEN, Marlborough, MA (US)

(21) Appl. No.: 16/206,384

(22) Filed: Nov. 30, 2018

Related U.S. Application Data
(63) Continuation-in-part of application No. 15/843,317, filed on Dec. 15, 2017, now abandoned.

(51) Int. Cl. C09D 133/14; C08G 63/688; C08F 220/18; C08K 5/3492; C08F 2/50; C08F 220/34

(52) U.S. Cl. CPC C09D 133/14; C08G 63/688; C08F 220/18; C08F 2220/343; C08F 2/50; C08F 220/34; C08F 2220/1875; C08K 5/34924

(57) ABSTRACT

The present invention provides ultraviolet (UV) curing acrylic compositions for use in making thermoformable hard coats for curved optical displays comprising: (a) one or more multifunctional (meth)acrylate diluents chosen from (a1) an aliphatic trifunctional (meth)acrylate monomer; (a2) an aliphatic tetrafunctional (meth)acrylate monomer; or (a3) an aliphatic pentafunctional (meth)acrylate monomer; (b) from 3 to 30 wt %, based on the total weight of monomer solids, of one or more one (meth)acrylate monomer containing an isocyanurate group; (c) from 5 to 40 wt %, based on the total weight of monomer solids, of one or more aliphatic urethane (meth)acrylate functional oligomer having from 6 to 12 (meth)acrylate groups; (d) from 2 to 10 wt %, based on total monomer solids, of one or more UV radical initiators; (e) from 10 to 30 wt %, based on the total weight of (a), (b), (c), and (d), of one or more sulfur-containing polyol (meth)acrylates; and (f) one or more organic solvents for the monomer composition. The composition has a viscosity measured by Anton Parr ASVM 3001 digital viscometer at 50 wt % solids of from 10 to 200 centipoise (cPs).

The present invention relates to compositions for use in ultraviolet (UV) curing coatings. More particularly, it relates to compositions comprising a UV curing reaction mixture of multi-ethylenically unsaturated (meth)acrylates, such UV curing reaction mixture being particularly suitable for use as an optically clear hardcoat.

Smart phones and other mobile or portable devices equipped with an optical display having a touch sensor with an exposed viewing surface made from glass or clear plastic films. These display surfaces have either poor impact resistance or poor abrasion resistance. During use, the viewing face of the display is susceptible to cracks, scratches, abrasion and smudges, which can cause the display to lose resolution and clarity, and sometimes becoming unreadable or inoperative. To protect such displays, multilayer protective films or coatings have been used containing a hardcoat, base substrate and an optical adhesive. The hardcoat provides hardness, scratch resistance and finger print removal; the base substrate provides impact resistance; and the adhesive ensures that the film firmly attaches to the device screen.

Recently, curved displays have emerged in smartphones, in part leading to increasing demand for curved hardcoat films to protect the display top surface. Such curved hardcoat films can be fabricated via thermo-molding processes to conform to curved display shapes. However, conventional hardcoat films are too rigid for use as thermo-formable materials; and thermo-formable hardcoat films available on the market are too soft for protecting optical displays, and are very easily damaged.

U.S. Pat. No. 6,489,376, to Khudyakov et al., discloses UV curable coating compositions comprising (a) a radiation curable oligomer, such as 50 to 95 wt. % of monomers, of a urethane acrylate oligomer, (b) a photoinitiator, and (c) a mixture of reactive diluents, such as in the amount of from 5 to 50 wt. % of monomers, comprising (i) at least one mono- or di-functional reactive diluent monomer and (ii) at least one polyfunctional reactive diluent. The compositions provide hardcoats for optical fiber. Difunctional urethane acrylates are disclosed which are urethane oligomers that contain two or more urethane linkages. The compositions fail to provide adequate combination of hardness and flexibility needed for use in making curved films that behave like hardcoats for protecting flat optical displays.

U.S. Pat. No. 6,265,476 discloses radiation curable binder compositions containing (a) a polymer, oligomer or monomer having at least one (meth)acrylate group, (b) an oligomer or monomer, exclusive of (meth)acrylate functional groups, having an ethylenically unsaturated functional group, and (c) an elongation promoter. The elongation promoter may be a sulfur-containing elongation promoter which is, upon exposure to radiation, able to react with the oligomer or monomer which is not a (meth)acrylate. The compositions fail to provide adequate combination of hardness and flexibility needed for use in making curved films that behave like hardcoats for protecting flat optical displays.

The present inventors have endeavored to solve the problem of providing hardcoat compositions for use in protecting optical displays, such as flexible or foldable displays. In one alternative aspect, the present compositions may also be useful in providing thermoformable hardcoat coatings for use in making curved and custom shapable films that behave like hardcoats for protecting flat optical displays.

1. In accordance with a first aspect of the present invention, an actinic radiation curable (meth)acrylic composition for use in hardcoats for optical displays comprising (a) 9 to 70 wt % of one or more, preferably, two or more, or, more preferably, all three multifunctional (meth)acrylate diluents chosen from (a1) an aliphatic trifunctional (meth)acrylate, preferably, acrylate, monomer (a2) an aliphatic tetrafunctional (meth)acrylate monomer; or (a3) an aliphatic pentafunctional (meth)acrylate, preferably, acrylate, monomer; (b) from 3 to 30 wt. %, or, preferably, from 10 to 30, based on the total weight of monomer solids, of one or more one (meth)acrylate, preferably, acrylate, monomer containing an isocyanurate group; (c) from 5 to 55 wt. %, or, preferably, from 10 to 50 wt. %, based on the total weight of monomer solids, of one or more aliphatic urethane (meth)acrylate, preferably, acrylate, functional oligomer having no fewer than 6 and up to 24 or, preferably, from 6 to 12 (meth)acrylate, preferably, acrylate, groups; (d) from 2 to 10 wt. % or, preferably, from 3 to 8 wt. %, based on total monomer solids, of one or more UV radical initiators, such as, for example, benzophenones, benzils (1,2-diketones), thioxanthones, (2-benzyl-2-dimethylamino-1-[4-(4-(4-morpholinyl)phenyl]-1-butanone),2,4,6-trimethyl-benzoyl)-diphenyl phosphine oxide, 1-hydroxy-cyclohexyl-phenyl-ketone, 2-hydroxy-2-methyl-1-phenyl-1-propanone), oligomeric 2-hydroxy-2-methyl-1-[4-(1-methylvinyl)phenyl] propanones, dihydro-5-(2-hydroxy-2-methyl-1-oxopropyl)-1,1,3-trimethyl-3-(4-(2-hydroxy-2-methyl-1oxopropyl)phenyl)-1H-indenes, and bis-benzophenones, or, preferably, oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, or α-[(4-benzoylphenoxy)-acetyl]-to-[[2-(4-benzoylphenoxy)-acetyl] oxy]-poly (oxy-1,4-butanediyl)); (e) one or more organic solvents for the monomer composition, such as, a ketone, for example, methyl ethyl ketone; an ether; an aliphatic or aromatic hydrocarbon; an aromatic alcohol or an alkanol, an ester, or the combination of the multiple functional groups on one chain, such as hydroxy ketone or propylene glycol methyl ether acetate, wherein the composition has a viscosity measured in accordance with ASTM D7042-16 (2016) using a viscometer (ASVM3001, Anton Parr, Ashland, Va.) at 25° C. and at 50 wt % solids in the organic solvent, such as propylene glycol methyl ether acetate (PGMEA), ranging from 10 to 2000 centipoise (cPs) or, preferably, from 20 to 400 cPs, wherein the total amount of monomer and functional oligomer solids amounts to 100%.

2. In accordance with an alternate first aspect of the present invention, an actinic radiation curable (meth)acrylic composition for use in hardcoats for optical displays comprising (a) 9 to 70 wt % of one or more, preferably, two or more, or, more preferably, all three multifunctional (meth)acrylate diluents chosen from (a1) an aliphatic trifunctional (meth)acrylate, preferably, acrylate, monomer (a2) an aliphatic tetrafunctional (meth)acrylate monomer; or (a3) an aliphatic pentafunctional (meth)acrylate, preferably, acrylate, monomer; (b) from 3 to 30 wt. %, or, preferably, from 10 to 30, based on the total weight of monomer solids, of one or more one (meth)acrylate, preferably, acrylate, monomer containing an isocyanurate group; (c) from 5 to 40 wt. %, or, preferably, from 10 to 40 wt. %, based on the total weight of monomer solids, of one or more aliphatic urethane (meth)acrylate, preferably, acrylate, functional oligomer having no fewer than 6 and up to 12 or, preferably, from 6 to 10 (meth)acrylate, preferably, acrylate, groups; (d) from 2 to 10 wt. % or, preferably, from 3 to 7 wt. %, based on total monomer solids, of one or more UV radical initiators, such as, for example, benzophenones, benzils (1,2-diketones), thioxanthones, (2-benzyl-2-dimethylamino-1-[4-(4-morpholinyl)phenyl]-1-butanone), 2,4,6-trimethyl-benzoyl)-diphenyl phosphine oxide, 1-hydroxy-cyclohexyl-phenyl-ketone, 2-hydroxy-2-methyl-1-phenyl-1-propanone), oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-2-hydroxy-2-methyl-1-oxopropyl)phenyl)-1H-indenes, and bis-benzophenones, or, preferably, oligomeric 2-hydroxy-2-methyl-1-[4-(1-methylvinyl)phenyl]propanones, dihydro-5-(2-hydroxy-2-methyl -1-oxopropyl)-1,1,3-trimethyl-3-(4-(2-hydroxy-2-methyl-1-oxopropyl)phenyl)-1H-indenes, or α-[(4-benzoylphenoxy)-acetyl]-ω-[[2-(4-benzoylphenoxy)-acetyl]oxy]-poly(oxy-1,4-butanediyl)); (e) from 10 to 30 wt %, based on the total weight of (a), (b), (c), and (d), of one or more sulfur-containing polyol (meth)acrylates; and (f) one or more organic solvents for the monomer composition, such as a ketone, for example, methyl ethyl ketone; a glycol ether; an aromatic hydrocarbon; an aromatic alcohol or an alkanol, wherein the composition has a viscosity measured in accordance with ASTM D7042-16 (2016) using a viscometer (ASVM3001, Anton Parr, Ashland, Va.) at 25° C. and at 50 wt % solids in the organic solvent, such as propylene glycol methyl ether acetate (PGMEA), ranging from 10 to 200 centipoise (cPs) or, preferably, from 20 to 150 cPs, wherein the total amount of monomer and functional oligomer solids amounts to 100%.

3. In accordance with the curable (meth)acrylic compositions of the first aspects of the present invention as in items 1 and 2, above, wherein the composition comprises (a) a multifunctional (meth)acrylate diluent of the (a1) one or more aliphatic trifunctional (meth)acrylate, preferably, acrylate, monomer, in the amount of from 3 to 25 wt % or, preferably, from 3 to 15 wt %, based on total monomer solids, wherein the total amount of monomer and functional oligomer solids amounts to 100%.

4. In accordance with the curable (meth)acrylic compositions of the first aspects of the present invention as in any one of items 1, 2 or 3, above, wherein the composition comprises (a) a multifunctional (meth)acrylate diluent of the (a2) one or more aliphatic tetrafunctional (meth)acrylate, preferably, acrylate, monomer, in the amount of from 3 to 25 wt % or, preferably, from 3 to 19 wt %, based on total monomer solids, wherein the total amount of monomer and functional oligomer solids amounts to 100%.

5. In accordance with the curable (meth)acrylic compositions of the first aspects of the present invention as in any one of items 1 to 4, above, wherein the composition comprises (a) a multifunctional (meth)acrylate diluent of the (a3) one or more aliphatic pentafunctional (meth)acrylate, preferably, acrylate, monomer, in the amount of from 3 to 25 wt % or, preferably, 3 to 15 wt %, based on total monomer solids, wherein the total amount of monomer and functional oligomer solids amounts to 100%.

6. In accordance with the curable (meth)acrylic compositions of the first aspects of the present invention as in items 1 and 2, above, wherein the composition comprises from 9 to 70 wt % in total or, preferably, from 9 to 60 wt % in total, based on total monomer solids, of the (a) multifunctional (meth)acrylate diluent which is two or more of the monomer (a1), the monomer (a2) or the monomer (a3), wherein the total amount of monomer and functional oligomer solids amounts to 100%.

7. In accordance with the curable (meth)acrylic compositions of the first aspects of the present invention as in any one of items 1 to 6, above, wherein at least one (c) aliphatic urethane (meth)acrylate functional oligomer has a formula molecular weight of from 1400 to 10000 or, preferably, from 1500 to 6000, or, more preferably, wherein the reacted isocyanate (carbamate) content of the composition, as solids, of the one or more (c) aliphatic urethane (meth)acrylate, preferably, acrylate, functional oligomer ranges from 5 to 60, more preferably 10 to 50 wt %.

8. In accordance with the curable (meth)acrylic compositions of the first aspects of the present invention as in any one of items 1 to 7, above, wherein the composition comprises from 0.1 to 30 wt %, or, preferably 20 wt % or less or, more preferably 16 wt % or less as solids, of one or more sulfur-containing polyol (meth)acrylates, such as mercapto modified polyester acrylics.

9. In accordance with the curable (meth)acrylic composition of the first aspects of the present invention as in any one of items 1 to 8, above, wherein the amount of the (e) one or more organic solvents ranges from 10 to 90 wt % or, preferably from 25 to 60 wt %, based on the total weight of the composition.

10. In accordance with the curable (meth)acrylic compositions of the first aspects of the present invention as in any one of items 1 to 9, above, wherein the composition comprises in total 5 wt % or less or, preferably 3.5 wt %, or less, as solids, of inorganic nanoparticle compounds, such as fillers, for example silica, alumina, ceria, titania, zirconia or any suitable metal or metal oxide nanoparticles having an average particle size of 1000 nm or less in diameter for the primary particle size, preferably 500 nm or less, more preferably 100 nm or less at the longest dimension, measured by Brunauer-Emmett-Teller analyzer. The nanoparticles can be symmetric, such as sphere, or non- symmetric, such as rod. They can be solid or hollow, or mesoporous. The nanoparticles may be individually dispersed or can be dispersed as aggregates in the composition. When the nanoparticles used are agglomerates, they have a secondary average particle size of less than 10000 nm, as measured by dynamic laser light scattering.

In a second aspect, the present invention comprises methods of making a coating from the curable (meth)acrylic compositions as in any one of the above items, wherein the methods comprise applying the compositions to a mold or a substrate, preferably a substrate at a suitable temperature, such as from 20 to 150° C., and preferably from 60 to 150° C., to form a film or coating, optionally removing organic solvent such as by heating to a temperature of 50 to 200° C., and curing the film with actinic radiation. Any suitable means of applying the present compositions to a mold or substrate comprises any known method, such as, but not limited to, drawdown bar coating, wire bar coating, slit coating, flexographic printing, imprinting, spray coating, dip coating, spin coating, flood coating, screen printing, inkjet printing, gravure coating, and the like. Any suitable substrate may be used in the present methods, and preferably such substrates are any which are used in flexible displays. Suitable substrates include, without limitation, polyesters, such as poly(ethyleneterephthalate) (PET), polyimides, polycarbonates, poly(methyl methacrylate), poly(cyclic olefins), poly(vinyl fluoride), glass, and the like.

Any suitable actinic radiation may be used to cure coatings of the present compositions Exemplary actinic radiation is any radiation having a wavelength in range of from 100 to 780 nm, and preferably actinic radiation having a peak maximum in the range of from 100 to 400 nm, such as UV. Preferred actinic radiation is provided by high pressure UV lamps, medium pressure UV lamps, fusion UV lamps, and LED lamps In one preferred aspect, the films of formed from the present compositions are cured by exposure to a a UV dosage of 480, 120, 35, and 570 mJ/cm² in the UVA, UVB, UVC, and UVV regimes, respectively, with a Fusion Systems UV belt system device (Heraeus Noblelight American, LLC, Gaithersburg, Md.), which is equipped with D lamp at a speed of 0.24 m/s.

In a third aspect, the present invention comprises hardcoat coatings of, in copolymerized form, (a) one or more, or, preferably two or more, or, more preferably three or more multifunctional (meth)acrylate diluents chosen from (a1) an aliphatic trifunctional (meth)acrylate, preferably acrylate, monomer; (a2) an aliphatic tetrafunctional (meth)acrylate, preferably acrylate, monomer; or (a3) an aliphatic pentafunctional (meth)acrylate, preferably acrylate, monomer; (b) from 3 to 30 wt %, or, preferably from 10 to 30 wt %, based on the total weight of polymerized monomer solids, of one or more one (meth)acrylate, preferably acrylate, monomer containing an isocyanurate group; (c) from 5 to 40 wt %, or, preferably from 10 to 40 wt %, based on the total weight of polymerized monomer solids, of one or more aliphatic urethane (meth)acrylate, preferably, acrylate, functional oligomer having no fewer than 6 and up to 12 or, preferably from 6 to 10 (meth)acrylate, preferably acrylate, groups; and (d) from 2 to 10 wt % or, preferably from 3 to 7 wt %, based on total polymerized monomer solids, of one or more UV radical initiators, such as, for example, benzophenones, benzils (1,2-diketones), thioxanthones, (2-benzyl-2-dimethylamino-1-[4-(4-morpholinyl)phenyl]-1-butanone), 2,4,6-trimethyl-benzoyl)-diphenyl phosphine oxide, 1-hydroxy-cyclohexyl-pheny-lketone, 2-hydroxy-2-methyl-1-phenyl-1-propanone), oligomeric 2-hydroxy-2-methyl-1-[4-(1-methylvinyl)phenyl]-propanones, dihydro-5-(2-hydroxy-2-methyl-1-oxopropyl)-1,1,3-trimethyl-3-(4-2-hydroxy-2-methyl-1-oxopropyl)phenyl)-1H-indenes, and bis-benzophenones such as α-[(4-benzoylphenoxy)acetyl]-ω-[[2-(4-benzoylphenoxy)acetyl]oxy]-poly(oxy-1,4-butanediyl)) or, preferably oligomeric 2-hydroxy-2-methyl-1-[4-(1-methylvinyl)phenyl] propanones, dihydro-5-(2-hydroxy-2-methyl-1-oxopropyl)-1,1,3-trimethyl-3-(4-(2-hydroxy-2-methyl-1-oxopropyl)-phenyl)-1H-indenes, or α-[(4-benzoylphenoxy)acetyl]-ω-[[2-(4-benzoylphenoxy)acetyl] oxy]-poly(oxy-1,4-butanediyl)) (CAS515136-48-8).

In an alternate third aspect, the present invention comprises hardcoat coatings of, in copolymerized form, (a) one or more, or, preferably two or more, or, more preferably three or more multifunctional (meth)acrylate diluents chosen from (a1) an aliphatic trifunctional (meth)acrylate, preferably acrylate, monomer; (a2) an aliphatic tetrafunctional (meth)acrylate, preferably acrylate, monomer; or (a3) an aliphatic pentafunctional (meth)acrylate, preferably acrylate, monomer; (b) from 3 to 30 wt %, or, preferably from 10 to 30 wt %, based on the total weight of polymerized monomer solids, of one or more one (meth)acrylate, preferably acrylate, monomer containing an isocyanurate group; (c) from 5 to 40 wt %, or, preferably from 10 to 40 wt %, based on the total weight of polymerized monomer solids, of one or more aliphatic urethane (meth)acrylate, preferably, acrylate, functional oligomer having no fewer than 6 and up to 12 or, preferably from 6 to 10 (meth)acrylate, preferably acrylate, groups; and (d) from 2 to 10 wt % or, preferably from 3 to 7 wt %, based on total polymerized monomer solids, of one or more UV radical initiators, such as, for example, benzophenones, benzils (1,2-diketones), thioxanthones, (2-benzyl-2-dimethylamino-1-[4-(4-morpholinyl)phenyl]-1-butanone), 2,4,6-trimethyl-benzoyl)-diphenyl phosphine oxide, 1-hydroxy-cyclohexyl-pheny-lketone, 2-hydroxy-2-methyl-1-phenyl-1-propanone), oligomeric 2-hydroxy-2-methyl-1-[4-1-methylvinyl)phenyl]-propanones, dihydro-5-(2-hydroxy-2-methyl-1-oxopropyl) -1,1,3-trimethyl-3-(4-(2-hydroxy-2-methyl-1-oxopropyl)phenyl)-1H-indenes, and bis-benzophenones such as α-[(4- benzoylphenoxy)acetyl]-ω-[[2-(4-benzoylphenoxy)acetyl]oxy]-poly(oxy-1,4-butanediyl)) or, preferably oligomeric 2-hydroxy-2-methyl-1-[4-(1-methylvinyl)phenyl] propanones, dihydro-5-(2-hydroxy-2-methyl-1-oxopropyl)-1,1,3-trimethyl-3-(4-(2-hydroxy-2-methyl-1-oxopropyl)-phenyl)-1H-indenes, or α-[(4- benzoylphenoxy)acetyl]-ω-[[2-(4-benzoylphenoxy)acetyl]oxy]-poly(oxy-1,4-butanediyl)) (CAS 515136-48-8); and (e) from 10 to 30 wt %, based on the total weight of (a), (b), (c), and (d), of one or more sulfur-containing polyol (meth)acrylates

In accordance with the hardcoating of the third aspects (that is, the third aspect and alternate third aspect) of the present invention, the coatings comprise, in copolymerized form, from 3 to 25 wt % or, preferably from 3 to 15 wt %, based on total polymerized monomer solids, of the (a1) one or more aliphatic trifunctional (meth)acrylate, preferably acrylate, monomer.

In accordance with the hardcoating of the third aspects of the present invention, the coatings comprise, in copolymerized form, from 3 to 25 wt % or, preferably from 3 to 15 wt %, based on the total weight of polymerized monomer solids, of the (a2) one or more aliphatic tetrafunctional (meth)acrylate, preferably acrylate, monomer.

In accordance with the hardcoating of the third aspects of the present invention, the coatings comprise, in copolymerized form, from 3 to 25 wt % or, preferably 3 to 15 wt %, based on the total weight of polymerized monomer solids, of the (c) one or more aliphatic pentafunctional (meth)acrylate, preferably acrylate, monomer.

In accordance with the hardcoating of the third aspects of the present invention, the coatings comprise, in copolymerized form, from 9 to 70 wt % in total or, preferably from 9 to 60 wt % in total, based on the total weight of polymerized monomer solids, of the a multifunctional (meth)acrylate diluent chosen from one or more, or, preferably two or more, or, more preferably all three of (a1) one or more aliphatic trifunctional (meth)acrylate, preferably acrylate, monomer, (a2) the one or more aliphatic tetrafunctional (meth)acrylate, preferably acrylate, monomer or (a3) the one or more aliphatic pentafunctional (meth)acrylate, preferably acrylate, monomer.

In accordance with the hardcoating of the third aspects of the present invention, the coatings comprise, in copolymerized form, 20 wt % or less or, preferably 15 wt % or less or, more preferably 10 wt % or less in total, based on the total weight of polymerized monomer solids, of mono- and di-functional(meth)acrylates.

In accordance with the hardcoating of the third aspects of the present invention, wherein at least one of the (c) aliphatic urethane (meth)acrylate, preferably acrylate, functional oligomer, in copolymerized form, has a formula molecular weight of from 1400 to 10000 or, preferably from 1500 to 6000, or, more preferably wherein the reacted isocyanate (carbamate) content of the hard coating comprises the one or more (c) aliphatic urethane (meth)acrylate functional oligomer, in copolymerized form, ranges from 10 to 50 wt %.

The compositions of the first aspects of the present invention contain from 2 to 30 wt %, preferably from 3 to 30 wt %, more preferably from 5 to 25 wt %, based on the total weight of (a), (b), (c), and (d), of one or more sulfur-containing polyol (meth)acrylates. Such sulfur-containing polyol (meth)acrylates can be used to promote the surface cure of the UV cured coatings made from the present compositions. Suitable sulfur-containing polyol (meth)acrylates have at least 2, preferably at least 3, preferably 6 or fewer, more preferably 5 or fewer, and even more preferably 2 to 6, (meth)acrylate functional groups. An exemplary sulfur-containing polyol (meth)acrylates is a mercapto modified polyester acrylic, sold as EBECRYL™ LED 02 or LED 01 (Annex Coating Resins, Frankfurt am Main, Germany).

In accordance with the hardcoat coatings of the third aspects of the present invention, the coatings have some elongation at break. For example, after curing with actinic radiation, particularly using an LED lamp or any suitable UV lamp described above, the coatings of the present invention having a thickness of 2-50 μm has an elongation at break of at least 2%, preferably 4% or more, and more preferably 7% or more as measured by tensile testing when elongated together with an underlying 50 μm PET substrate (Melinex™ 462 polyester, Tekra, a Division of EIS, Inc., New Berlin, Wis.) at room temperature and a loading rate of 1 mm/min.

In accordance with the hard coating of the third aspects of the present invention, the coating comprises a transparent multilayer article of a layer of the hard coating over a substrate, PET, polyimides, polycarbonates, poly(methyl methacrylate), poly(cyclic olefins), poly(vinyl fluoride), glass, and the like. Further, such multilayer article is adhered by a layer of an optical adhesive to a glass optical display.

All ranges are inclusive and combinable. For example, a weight percentage of from 0.1 to 1 wt %, preferably 0.2 wt % or more, or, preferably up to 0.6 wt % includes ranges of from 0.1 to 0.2 wt %, from 0.1 to 0.6 wt %, from 0.2 to 0.6 wt %, from 0.2 to 1.0 wt %, or from 0.1 to 1.0 wt %.

The term “(meth)acrylate” refers to any of an acrylate, a methacrylate, and mixtures thereof.

Unless otherwise specified, all temperature units refer to room temperature (˜20-22° C.) and all pressure units refer to standard pressure.

As used herein, the term “ASTM” refers to the ASTM International of West Conshohocken, Pa.

As used herein, the term “average number of ethylenically unsaturated groups” in a multi-ethylenically unsaturated (meth)acrylate monomer composition is a weighted average number of ethylenically unsaturated groups in each of the monomers in that composition. Thus, for example, when such (meth)acrylate compositions comprise only one multi-ethylenically unsaturated acrylate monomer, the composition is said to comprise the average number of ethylenically unsaturated groups reported for that monomer in the monomer supplier's product literature, such as 4 for a tetraacrylate; and, for example, when a composition comprises a 50/50 wt % monomer blend of each of a triacrylate and a tetraacrylate, the composition has monomer composition with an average of 3.5 ethylenically unsaturated groups.

As used herein, the term “calculated glass transition temperature (T_{g})” means the result determined by plugging the report glass transition temperature of the monomers of a given composition into the Flory-Fox Equation, as follows:

$$\frac{1}{{T}_{g}} = \frac{{w}_{1}}{{T}_{g , 1 }} + \frac{{w}_{2}}{{T}_{g , 2}}$$

The T_{g} values for a given monomer are available from the manufacturer or can be measured by DSC or OMA.

As used herein, the term “carbamate” refers to a urethane or (—RNCOOR′—) group which is the reaction product of an isocyanate group RNCO and an alcohol R′OH or other active hydrogen.

As used herein, the term “based on total monomer solids” includes both monomer solids and functional oligomer solids.

As used herein, unless otherwise indicated, the term “molecular weight” or “formula molecular weight” means a formula weight for a given material as reported by its manufacturer or, if so indicated, as determined by totaling the molar mass of a formula of the monomer. As used herein, the term “average molecular weight” refers to the molecular weight reported for a distribution of molecules in a given material, e.g. a polymer distribution.

As used herein, the term “elongation at break” refers to the result of testing a cured 5 μm thick coating on a PET substrate, cut to specimens 15 mm wide and of a 100 mm long, wherein specimens of a 60 mm gauge length were loaded in tension into the pneumatic grips of a mechanical tester preloaded to 1 MPa in tensile stress (Instron™ model 33R4464, table top load frame, Instron, an ITW company, Norwood, Mass.) and tested at the loading rate of 1 mm/min until a vertical crack was observed. During the tensile test, the specimens were under a white LED light for easier crack detection. Once a crack is found in the specimens, the loading was immediately stopped and corresponding tensile strain was reported as elongation-to-break.

As used herein, unless otherwise indicated, the term “number of ethylenically unsaturated groups” in a multi-ethylenically unsaturated (meth)acrylate composition refers to the number of acrylate groups in that monomer according to the monomer or oligomer supplier's product literature.

As used herein, the term “reacted isocyanate (carbamate) content” means any carbamate (—NCOO—) group which has formed a urethane and includes the weight of the NCO moiety in the urethane as well as a single extra oxygen but not the corresponding hydrocarbyl or active hydrogen substituents of the carbamate, such as a polymer dial, or the content thereof.

As used herein, the term “solids” means any material other than water or ammonia that does not volatilize in use conditions, no matter what its physical state, and including all oligomers, monomers and all non-volatile additives. Solids excludes water and volatile solvents. Thus, liquid reactants that do not volatilize in use conditions are considered “solids”.

As used herein, the term “viscosity” means the result obtained in centipoises (cPs) in accordance with the ASTM D7042-16 (2016) method at 25° C. of a 50 wt % solids solution of the indicated composition in the organic solvent, such as PGMEA, as determined by a viscometer (ASVM3001, Anton Parr, Ashland, Va.) wherein an 1.5 mL solution was filled in a cell, which was cleaned with PGMEA. The viscometer was calibrated using the certified reference standards as described in section 9.2 of ASTM D7042-16. As used herein, the term “wt %” stands for weight percent.

The present inventors have discovered a way to make the curable (meth)acrylic coating compositions for colorless, transparent thermoformable hardcoatings that provides hard coatings that exhibit hardness comparable to the conventional hardcoats as well as thermo-formability so as to conform to a curved optical display. The hardcoatings may be laminated or coated on an protective polymer layer, for example, PET layer, over a glass display screen. The thermoformable hardcoatings can change shape at a high (˜50 to 160° C.) temperature because they remain soft, even though not fluid. The flexibility of the hard coatings enables them to retain an aspect of softness at ambient temperature.

The hardcoatings in accordance with the present invention are formed by curing an inventive UV curing acrylic composition. In the UV curing acrylic composition, the amount of aliphatic urethane (meth)acrylate functional oligomer remains high so as to avoid yellowing during the use. At the same time, the cured hard coatings in accordance with the present invention have a calculated glass transition temperature (T_{g}) of from 70 to 120° C.

In the curable (meth)acrylic compositions of the present invention, the aliphatic urethane (meth)acrylate functional oligomer and the multi-ethylenically unsaturated monomers confer both flexibility and hardness to hard coat network through secondary bond interactions.

In accordance with the UV curing acrylic composition of the first aspect of the present invention, the aliphatic urethane (meth)acrylate functional oligomer can be an aliphatic version of the compound of formula I, below, wherein R or R′ R″ (linear or branched polyethylene or polypropylene glycol) are branched and have (meth)acrylate groups at their termini to give a total of from 6 to 24 (meth)acrylates.

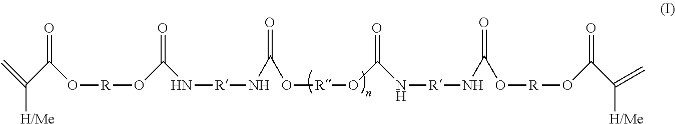

Preferably, in accordance with the present invention, the aliphatic urethane (meth)acrylate functional oligomer comprises a urethane which is the reaction product of three moles of a triisocyanate such as an aliphatic triisocyanate, such as hexamethylene triisocyanate (HMTI) an alicyclic triisocyanate, such as dicyclohexyl methane diisocyanate with one and a half moles of propylene glycol or ethylene glycol. Further, the preferred aliphatic urethane (meth)acrylate functional oligomer comprises the reaction product of the urethane and a hydroxyalkyl (meth)acrylate in an equimolar amount of the hydroxyalkyl(meth)acrylate and the triisocyanate.

Preferably, the aliphatic urethane (meth)acrylate functional oligomer in accordance with the present invention contains no residual isocyanate or unreacted hydroxyalkyl groups in the hydroxyalkyl (meth)acrylate.

The molecular weight and the amount of aliphatic urethane (meth)acrylate functional oligomer as well as the isocyanurate containing (meth)acrylate of the present invention is limited in molecular weight so that the viscosity of the composition remains workable in the conditions of the methods of making a coating in accordance with the present invention.

The amount of the isocyanurate containing (meth)acrylate in accordance with the present invention is limited to ensure that the viscosity of the composition remains workable in the conditions of the methods of making a coating in accordance with the present invention.

To ensure proper coating hardness in accordance with the UV curing acrylic composition of the present invention, a multifunctional (meth)acrylate diluent of one or, or, preferably, two of, or, more preferably each of (a1) an aliphatic trifunctional acrylic monomer, (a2) an aliphatic tetrafunctional acrylic monomer and (a3) an aliphatic pentafunctional acrylic monomer is present in the amount of from 3 to 25 wt %, based on the total monomer solids of the UV curing acrylic composition.

The UV curing acrylic compositions also comprise a sufficient amount of a photoinitiator, such as camphorquinone, to insure cure in a reasonable time, such as from 2 to 10 wt %, or, preferably from 3 to 7 wt %, based on monomer solids.

Suitable photoinitiators may include, for example, a-hydroxyketones, such as DAROCUR™ 1173, a 2-hydroxy-2-methy-11-phenyl-propan-1-one (BASF, Germany), benzophenones benzoin dimethyl ether, 2-hydroxyl-2-methyl-1-phenyl acetone, 1-hydroxyl-cyclohexyl phenyl acetone, phenylglyoxylates1,2,2-dimethoxy-2-diphenyl butanone, di(2,4,6-trimethyl benzoyl)phenylphosphine oxide, benzyldimethyl-ketal, alpha-aminoketone, monoacyl phosphines, bisacyl phosphines, phosphine oxides and diethoxyacetophenone (DEAP), and their mixtures (such as Esacure KTO 46 from IGM).

Examples of commercially available photoinitiators may also include ESACURE™ ONE (IGM Resins BV, Waalwijk, NL, CAS: 163702-01-0 oligo(2-hydroxy-2-methyl-1-[4-(1-methylvinyl)phenyl]propanone) and OMNIPOL™ BP ((IGM, CAS 515136-48-8, α-[(4-benzoylphenoxy)acetyl]-ω-[[2-(4-benzoylphenoxy)acetyl]oxy]-poly(oxy-1,4-butanediyl))

To insure their transparency and limit viscosity, the curable (meth)acrylic compositions of the present invention may contain 5 wt % or less, preferably 3.5 wt % or less, of inorganic nanoparticle fillers. When used in too large an amount, such as >5wt %, inorganic fillers can negatively affect the thermo-formability or cause haze or limit elongation. Suitable fillers include, without limitation, silica particles, metal oxide particles such as alumina, zirconia, and the like. Any suitable silica particles may be used, such as fumed, colloidal, and the like. Fillers useful in the present invention may optionally be surface modified or otherwise surface treated, and are well-known in the art. Suitable inorganic nanoparticles have an average particle size of 100 nm or less in diameter

Solvents as diluents can be added to tune viscosity of the curable (meth)acrylic composition to satisfy the coating requirement. Suitable solvents are generally liquids which are inert toward the (meth)acrylate monomers under the reaction conditions, examples being ethers such as ethylene glycol ethers and ethylene diglycol ethers; esters such as butyl acetate; ketones such as methyl amyl ketone; and aliphatic alcohols, such as isopropanol, etc.

The curable (meth)acrylic compositions in accordance with the present invention can further comprise fluorinated additives, silicone containing additives, such as mold release agents, slip agents, and/or anti-fingerprint agents, etc. in the amount of less than 5 wt %, based on total resin solids or, preferably, from 0.1 to 3 wt. % of solids.

In an alternate aspect, the present invention provides multilayer films for protecting curved optical displays which comprise the hardcoat of the present invention, a transparent substrate, such as a polymer film, and an optical adhesive for bonding the film to the optical display. The transparent substrate may be any as described above, for example, PET or a polyimide, but could be other polymers or glass, such as polycarbonate, PMMA or flexible or non-flexible glass.

In a further aspect, films formed from the present compositions may be subjected to additional thermal treatment steps before and/or after curing, such as tempering at from 50 to 150° C. may be useful to tune the coating properties. In addition, humidity treatments during and/or after curing are not necessary to make the coating of the present invention.

### EXAMPLES

### The Following Examples Seek to Illustrate the Present Invention

All materials including photoradical initiators, (meth)acrylate monomers, aliphatic urethane (meth)acrylate functional oligomers, solvents, PET (Mellinex™ 462 polyester, Tekra, a division of EIS, Inc., New Berlin, Wis.), were used as received unless specified otherwise.

The following test methods were used in the following Examples:

Elonation-to-break: An Instron mechanical tester was used to measure the elongation-to-break of coatings. Cured coatings on PET substrates were cut to specimens in 15 mm wide and 100 mm long. Next, specimens with 60 mm gauge length were gripped by pneumatic grips and then preloaded to 1 MPa in tensile stress. Then, the specimens were loaded in tension at the loading rate of 1 mm/min until a vertical crack was observed. During the tensile test, the specimens were under a white LED light for easier crack detection. Once a crack was found in the specimens, the loading was immediately stopped and corresponding tensile strain was reported as elongation-to-break. A result of at least >2% is acceptable, and >4% is preferred.

Haze: A BYK haze measurement system (Byk Gardner, Geretsried, Germany) was used to measure the haze of the indicated coatings. The haze values were obtained based on ASTM D1003 standard (2013). A % transparency of >90% (550 nm) and a % haze of <2 is acceptable. The same transparency and % Haze below 1 is preferred.

Indentation modulus (E, GPa and hardness (H, GPal: A Nanoindenter iMicro™ (Nanomechanics, Tennessee) was used to characterize the indentation modulus and hardness of cured hardcoatings. The nanoindenter had load and displacement resolutions of 6 nN and 0.04 nm, respectively, and was operated in continuous stiffness mode in which the indenter tip was continuously oscillated at a 2 nm amplitude for improved surface detection and extraction from a single measurement of mechanical properties as a function of indentation depth. A standard Berkovich tip whose projected contact area function was calibrated to an indentation depth of from 200 and 2000 nm was used by making 20-25 indentations on a fused silica specimen with an indentation modulus of 72 GPa±1 GPa. The indicated cured hardcoatings were mounted on sample holders using a hot melt adhesive with a melting point of circa 54° C. (Crystal Bond™ 555, TedPella, Inc., Redding, Calif.). Indentations to 2000 nm depth were made on each coating in at least 10 different locations once the test system had reached a thermal drift of <0.1 nm/sec. A Poisson's ratio of 0.3 was assumed. Subsequent to the measurement, 3 to 5 indentations were again made on the fused silica specimen to verify the previous calibration. Adequate hardness comprises a modulus greater than 4 GPa and a hardness of at least >0.3 GPa.

Outward bending radius: The outward bending radius of cured coatings was measured using a manual cylindrical bend tester (TQC). The tester was equipped with smooth metal mandrels having different diameters (32, 25, 20, 19, 16, 13, 12, 10, 8, 6, 5, 4, 3, and 2 mm) to apply discrete sets of strain to cured coatings. Cured coatings with a thickness of ˜2-50 μm on 50 μm PET were used. One side of the cured film was fixed at the bottom of the equipment, and a smooth metal mandrel with a desired diameter was set in the tester. Note that for the initial test, mandrels with sufficiently large diameters were chosen so as not to cause cracking in cured coatings. Then, the cured coating was lightly sandwiched between the mandrel and plastic cylinders such that only tensile bending strain was applied to the top side of the coatings. Subsequently, the cured coating was bent to the radius of the metal mandrel. After the bending, the coating was detached from the tester for visual crack detection. This process was repeated using mandrel with smaller diameter size until a crack was formed. Once a crack was detected, the smallest mandrel diameter without cracking was converted into an outward bending radius (dividing diameter by 2) and reported. Bending radius below and/or equal to 2 mm is acceptable; and below 1 mm is preferred. Pencil hardness: Pencil hardness (ASTM standard D3363 (2011)) measurements of coatings cured as indicated were measured using an automatic pencil hardness tester (PPT-2016, Proyes International Corp., TaiChung, Taiwan). The test was performed at a 10 mm/min speed and at a 0.75 kgf vertical load using UNI™ pencils (Mitsubishi, Japan). During testing, the cured coatings were placed on a flat, clean and 0.5 cm thick glass plate. An acceptable result is greater than or equal to 4H.

Hardcoating thickness: Coating thickness was measured by a micrometer (Mitsutoyo, Japan). The micrometer was re-zeroed before measurements, and subsequently multiple locations on a given hard coating were measured.

The UV curing acrylic compositions indicated in Tables 1 and 2, below, were prepared by mixing the indicated constituents using a vortex and optionally a speed mixer at room temperature. The final compositions were left on a slow rotary mixer from 1 to 72 hours until all of the components were dissolved and became a clear solution in an ambient lab environment to ensure homogenous mixing before film preparation. Preferably, the total mixing time was 1 to 24 hours. The solution can also be heated up to 60° C. during mixing.

Film casting: PET substrates were cleaned with a jet of filtered laboratory air. An automatic draw-down coater (ElcometerUSA, Rochester Hills, Mich.) was used to cast the indicated compositions on PET substrates at room temperature. Draw-down bars with different gaps were used to obtain desired coatings at a thickness of 2˜50 μm. The films were then UV-cured using a Fusion™ 300 conveyor system (irradiance ˜3000 mW/cm², Fusion Systems, Inc., Gaithersburg, Md.). Each film passed the lamp four times 0.24 m/s. The average values for energy density at 0.24 m/s are around 480, 120, 35, and 570 mJ/cm² in the UVA, UVB, UVC, and UVV regimes, respectively.

In the Examples below, the following materials were used:

DPEPA: Dipentaerythritol pentaacrylate ester: (SR399™ Sartomer, Exton, Pa.), CAS# 60506-81-2, ≤100 wt %; SR399 is a mixture of tetra-, penta-, and hexa-acrylate; tentative molar ratio of acrylates is 25:50:25;

MEDA: 2-Propenoic acid, (5-ethyl-1,3-dioxan-5-yl)methyl ester: SR531 (Sartomer, f=1 CAS#66492-51-1, ≤95%); also includes a) 2-Propenoic acid, 2-ethyl-2-[[(1-oxo-2-propenyl)oxy]methyl]-1,3-propanediyl ester, f=3 CAS# 15625-89-5, ≤5%; b) Phenol, 2,6-bis(1,1-dimethylethyl)-4-methyl-(aka BHT), CAS # 128-37-0, ≤1%; and c) 2-Propenoic acid (acrylic acid), f=1, CAS# 79-10-7, ≤0.1%;

Monomer 2: Isobornyl acrylate, SR506C (Sartomer, f=1 CAS# 5888-33-5);

THEIA: Tris(2-hydroxyethyl)isocyanurate triacrylate: Photomer™ 4356 (IGM, United States, f=3, Cas# 40220-08-4, >98%; also includes acrylic acid, <1%;

Photoinitiator 1: Oligo[2-hydroxy-2-methyl-1-[4-(1-methylvinyl)phenyl]propanone](EsacureT™ One, IGM Resins B.V. , Waalwijk, NL, CAS# 163702-01-0);

Photoinitiator 2. Omnipol™ BP (CAS 515136-48-8, α-[(4-benzoylphenoxy)acetyl]-ω-[[2-(4-benzoylphenoxy)acetyl]oxy]-poly(oxy-1,4-butanediyl));

Photoinitiator 3: mixture of: diphenyl(2,4,6-trimethylbenzoyl)phosphine oxide 40-70%, 2-hydroxy-2-methylpropiophenone 15-40%, 2,4,6-trimethylbenzophenone 5-10%, 2-methylbenzophenone 0.1-1.0%, and 15-40% based on a mixture of 2,3-dihydro-6-(2-hydroxy-2-methyl-1-oxopropyl)-1,1,3-trimethyl-3-[4-(2-hydroxy-2-methyl-1- oxopropyl)phenyl]-1H-indene and 2,3-dihydro-5-(2-hydroxy-2-methyl-1-oxopropyl)-1,1,3-trimethyl-3-[4-(2-hydroxy-2-methyl-1-oxopropyl)phenyl]-1H-indene (Esacure™ KTO 46, IGM Resins USA Inc. Charlotte, N.C.);

HUA; Aliphatic urethane acrylate: CN9006 (Sartomer, f=6, CAS# proprietary, ≥30 to <60% (GPC analysis of main oligomer: Mw=1.5 kDa, Mn=1.3 kDa, PDI=1.20); also includes a) 2-propenoic acid, 2-(hydroxymethyl)-2-[[(1-oxo-2-propenyl)oxy]methyl]-1,3-propanediyl ester, f=3; CAS# 3524-68-3, ≥10-<30%; b) 2-propenoic acid, 2,2-bis[[(1-oxo-2-propenyl)oxy]methyl]-1,3-propanediyl ester, f=4; CAS# 4986-89-4, ≥10 to <30%; other acrylates, f=unknown, >=10-<30%;

Urethane nonaacrylate: CN9013 (Sartomer, f=9, CAS proprietary, ≤100%);

Silicone (non-reactive): BYK307™ additive (BYK USA, Chester, Pa.);

Aluminum oxide: NANOBYK3601 (BYK);

HUA 2: Urethane acrylate CN9025 (Sartomer, CAS# Proprietary aliphatic, f=6, ≥60 to ≤100%; also contains Proprietary Acrylic ester, f=6, ≥10 to <30%);

TUA: urethane acrylate oligomer: Photomer™ 6008 (IGM, CAS proprietary, f=3); also contains tripropylene glycol diacrylate, CAS# 42978-66-5, 15-25%; b) 2-hydroxyethyl acrylate, CAS# 818-61-1, <2%;

Alicyclic TUA: Methylenedi-4,1-cyclohexyleneisocyanate, (2-hydroxyethyl)-2-propenoate, α-hydro-ω-hydroxypoly(oxy-1,4-butanediyl)polymer: Photomer™ 6010 (IGM, CAS# 67599-25-1, f=3, >85%); also contains a) ethoxylated (3) trimethylolpropane triacrylate, CAS# 28961-43-5, f=3, >10 to <15%; b) 2-hydroxyethyl acrylate, <1%; and c) hydroquinone <0.05%;

Silica: X12-2444 silica nanoparticles in multifunctional acrylate (Shin Etsu Chemical, Ltd., Tokyo, Japan);

Fluorocompound: Optool™ DAC-HP (Daikin America, Inc., Orangeburg, N.Y.), contains 1,1,2,2,3,3,4-heptafluorocyclopentane 45-55%; 1-methoxy-2-propanol 25-35%; and 15-25% of a proprietary fluorocompound;

AUA: radiation curable mixture of aliphatic urethane acrylate resin 60-65%, and acrylates 35-40% (Ebecryl™ 8602, Allnex USA Inc., Alpharetta, Ga.);

S-(meth)acrylate: radiation curable mixture of acrylated resin and mercapto derivative (Ebecryl™ LED 02 Allnex USA Inc., Alpharetta, Ga.), contains polyol acrylate 30-90% and mercapto derivative 1-<25%; and

PETMP: pentaerythritol tetrakis (3-mercaptopropionate).

TABLE 1
Inventive Compositions and Performance

| | Example¹ | | |
|---|---|---|---|
| | 1 | 2 | 3 |
| MEDA | 10 | 10 | 10 |
| (acrylate monomer (f = 1)) | | | |
| DPEPA | 20 | 20 | 10 |
| Acrylate monomer f = 5 | | | |
| THEIA | 20 | 20 | 30 |
| Acrylate monomer with isocyanurate | | | |
| HUA: Urethane oligomer (f = 6) | 45 | 20 | 35 |
| Acrylate monomer (f = 3) Acrylate | | | |
| monomer (f = 4) | | | |
| Urethane nonaacrylate (f = 9) | — | 25 | |
| Photoinitiator 2 | 2 | 2 | 2 |
| Photoinitiator 1 | 3 | 3 | 3 |
| Pencil hardness | 7H | 4H | 7H |
| (0.75 kg, thickness 50 μm) | | | |
| Outward radius (mm); Thickness | <1; 13 | <1; 9 | <1; 9 |
| (μm) | | | |

¹f represents functionality.

As shown in Examples 1 to 3, the inventive compositions provide hard coatings having both acceptable pencil hardness andflexibility, as shown in outward radius.

TABLE 2
Comparative Compositions and Performance

| | Example¹ | | | | | |
|---|---|---|---|---|---|---|
| | 4* | 5* | 6* | 7* | 8* | 9* |
| MEDA | 10 | 10 | 10 | 10 | 10 | 10 |
| (acrylate monomer (f = 1)) | | | | | | |
| Monomer 2 | 20 | 20 | 20 | 20 | 20 | — |
| (acrylate monomer (f = 1)) | | | | | | |
| DPEPA | — | — | — | — | — | 20 |
| Acrylate monomer f = 5 | | | | | | |
| THEIA | — | — | — | 30 | 25 | 20 |
| Acrylate monomer with isocyanurate | | | | | | |
| Silica | — | — | 20 | — | — | — |
| HUA: Urethane oligomer (f = 6) | 65 | — | 45 | 35 | 50 | — |
| Acrylate monomer (f = 3) | | | | | | |
| Acrylate monomer (f = 4) | | | | | | |
| TUA (f = 3) | — | 65 | — | — | — | — |
| Urethane nonaacrylate (f = 9) | — | — | — | — | — | 45 |
| Photoinitiator 2 | 2 | 2 | 2 | 2 | 2 | 2 |
| Photoinitiator 1 | 3 | 3 | 3 | 3 | 3 | 3 |
| Pencil hardness | 2H | <6B | 2H | 3H | H | 3H |
| (0.75 kg, thickness 50 μm) | | | | | | |
| Outward radius (mm); | — | — | — | <1; | <1; | <1; |
| Thickness (μm) | | | | 10 | 7 | 9 |

¹*Denotes Comparative Example;
f represents functionality.

As shown in Table 2, above, none of the Comparative Examples 4 to 9 gave the acceptable pencil hardness for a thermoformable coating in accordance with the present invention. All of Comparative Examples 4 to 8 contain too much mono (meth)acrylate monomer; this is so even when the example contains adequate aliphatic urethane (meth)acrylate functional oligomer and isocyanurate(meth)acrylate monomer, as in Comparative Examples 7, and 8. Comparative Example9 fails to contain any aliphatic tetrafunctional (meth)acrylate. Comparative Example 6 contains too much silica or filler.

TABLE 3

| | Example¹ | | | |
|---|---|---|---|---|
| | 10 | 11 | 12* | 13* |
| S-(meth)acrylate | 10 | 15 | — | — |
| PETMP | — | — | 10 | — |
| DPEPA | 20 | 15 | 20 | 20 |
| Acrylate monomer f = 5 | | | | |
| THEIA | 20 | 20 | 20 | 20 |
| Acrylate monomer with isocyanurate | | | | |
| Aluminum oxide | 0.3 | 0.3 | 0.3 | 0.3 |
| AUA | 45 | 45 | 45 | 45 |
| Photoinitiator 3 | 5 | 5 | 5 | 5 |
| Fluorocompound | 0.2 | 0.2 | 0.2 | 0.2 |
| Pencil hardness | 3H | 3H | 2H | 2H |
| (0.75 kg, thickness 5 μm) | | | | |
| Outward radius (mm); | <1 | <1 | <1 | 1 |
| Thickness (μm) | 5 | 5 | 5 | 5 |
| Elongation to break (%) | 7 | 13 | 9 | 4.6 |

¹*denotes Comparative Example;
f = functionality (number of functional groups)

Examples 10, 11: with S-Metha(acrylate) in the formulation, the hard coat not only has high hardness but also high elongation at break at the film thickness around 5 μm. For Example 12, using mercapto small molecule, such as pentaerythritol tetrakis (3-mercaptopropionate, the film could not achieve acceptable pencil hardness. Without the sulfur-containing (meth)acrylate of the invention., the resulting film cannot achieve both good hardness and elongation at break.

We claim:

1. An actinic radiation curable (meth)acrylic composition for use in hardcoats for optical displays comprising: (a) 9 to 70 wt % of one or more multifunctional (meth)acrylate diluents chosen from (a1) an aliphatic trifunctional (meth)acrylate monomer, (a2) an aliphatic tetrafunctional (meth)acrylate monomer, and (a3) an aliphatic pentafunctional (meth)acrylate monomer; (b) from 3 to 30 wt %, based on the total weight of monomer solids, of one or more (meth)acrylate monomer containing an isocyanurate group; (c) from 5 to 55 wt %, based on the total weight of monomer solids, of one or more aliphatic urethane (meth)acrylate functional oligomer having from 6 to 12 (meth)acrylate groups; (d) from 2 to 10 wt %, based on total monomer solids, of one or more UV radical initiators; (e) from 10 to 30 wt %, based on the total weight of (a), (b), (c), and (d), of one or more sulfur-containing polyol (meth)acrylates; and (f) one or more organic solvents for the monomer composition, wherein the composition has a viscosity measured by Anton Parr ASVM 3001, at 50 wt % solids of from 10 to 3000 centipoise (cPs), wherein the total amount of monomer and functional oligomer solids amounts to 100%.

2. The composition of claim 1 comprising: from 3 to 25 wt %, based on total monomer solids, of (a) the multifunctional (meth)acrylate diluent (a1) one or more aliphatic trifunctional (meth)acrylate monomer, wherein the total amount of monomer and functional oligomer solids amounts to 100%.

3. The composition of claim 1 comprising: from 3 to 25 wt % or, based on total monomer solids, of (a) the multifunctional (meth)acrylate diluent (a2) one or more aliphatic tetrafunctional (meth)acrylate, monomer, wherein the total amount of monomer and functional oligomer solids amounts to 100%.

4. The composition of claim 1 comprising: from 3 to 25 wt %, based on total monomer solids, of (a) the multifunctional (meth)acrylate diluent (a3) one or more aliphatic pentafunctional (meth)acrylate, monomer, wherein the total amount of monomer and functional oligomer solids amounts to 100%.

5. The composition of claim 1 comprising: from 9 to 70 wt % in total, based on total monomer solids, of (a) two or more multifunctional (meth)acrylate diluent monomers chosen from the (a1) aliphatic trifunctional (meth)acrylate monomer, (a2) the aliphatic tetrafunctional (meth)acrylate monomer or (a3) the aliphatic pentafunctional (meth)acrylate monomer, wherein the total amount of monomer and functional oligomer solids amounts to 100%.

6. The composition of claim 1 comprising: (b) from 10 to 30 wt %, based on the total weight of monomer solids, of one or more one (meth)acrylate monomer containing an isocyanurate group, wherein the total amount of monomer and functional oligomer solids amounts to 100%.

7. The composition of claim 1 comprising: (c) from 5 to 55 wt %, based on the total weight of monomer solids, of one or more aliphatic oligomer having from 6 to 24 (meth)acrylate groups, wherein the total amount of monomer and functional oligomer solids amounts to 100%.

8. The composition of claim 1, wherein the at least one (c) aliphatic urethane (meth)acrylate functional oligomer has a formula molecular weight of from 1400 to 10000.

9. The composition of claim 1, wherein the amount of the (e) one or more organic solvents ranges from 10 to 90 wt %, based on the total weight of the composition.

10. The composition of claim 1, wherein the sulfur-containing polyester (meth)acrylates is a mercapto modified polyester (meth)acrylate, having a functionality of 2 to 6.

11. The composition of claim 1, further comprising 5 wt % or less, as solids, of inorganic nanoparticle compounds.
